(19) United States
(12) Patent Application Publication
(10) Pub. No.: US 2014/0343988 A1
(43) Pub. Date: Nov. 20, 2014

(54) AUTOMATIC RESOURCE SCHEDULING

(71) Applicant: Microsoft Corporation, Redmond, WA (US)

(72) Inventors: Babak Nakhayi Ashtiani, Redmond, WA (US); Brian Welcker, Seattle, WA (US); Thomas Chan, Redmond, WA (US); Qian Jiang, Bothell, WA (US)

(21) Appl. No.: 13/893,346

(22) Filed: May 14, 2013

(51) Int. Cl. G06Q 10/06

(52) U.S. Cl. CPC G06Q 10/063118
USPC 705/7.17

(57) ABSTRACT

An activity is selected. Resource requirement user inputs, indicative of resource requirements for the activity, are received, as are priorities identifying which of the resource requirements are more important than others. Resources are automatically identified based on how well they match the resource requirements, as prioritized, and based on availability. The identified resources are automatically assigned to the activity.

### BACKGROUND

Many projects are broken down into activities. Each of the activities need to be performed in order to complete the project. This means that someone needs to locate the resources that are needed in order to complete the activities, so that the project can be completed.

In one example, a business system allows a project manager (or other user) to define a project in terms of an activity breakdown structure. The activity breakdown structure can represent a hierarchical view of the various activities that are to be completed in the performance of a project. For instance, a project may have a planning phase where a number of activities are performed in order to plan the project. It may then be followed by a design phase where components of the project are designed, and a build phase where the components are built, and finally a test phase, where the system is tested. Each of the phases may have a plurality of different activities associated with it.

Each activity may require a number of different resources for its completion. For instance, during the design phase, the needed resources may include various types of engineers, supervisors, programmers, etc. Of course, this activity breakdown structure is exemplary only. In actuality, the activity breakdown structure may have far more phases, each with many activities and requiring many different types of resources.

Currently, identifying resources that are not only qualified to perform the activities, but that are also available during the time frame needed by the project, is a manually intensive process. This often involves a project manager (or other user) searching for individuals who may have the skills to perform the activities. It then often involves the user checking the calendars of those individuals who have been identified to see whether they are even available to perform the tasks. If so, the user assigns those individuals to those tasks in the relevant time periods. Even after all of this manual searching and scheduling, there is often no way for the user to know he or she has even identified the most highly qualified individuals.

The problem of assigning resources to an activity is also exacerbated where multiple resources must be assigned to a single task. For example, where one individual is qualified to perform the task, but only has availability for half of the time required to perform the task, the user must then find another qualified individual that has the availability to perform the remainder of the task. It can thus be seen that the location and assignment of resources has been very time consuming, cumbersome, and labor intensive.

The discussion above is merely provided for general background information and is not intended to be used as an aid in determining the scope of the claimed subject matter.

### SUMMARY

An activity is selected. Resource requirement user inputs, indicative of resource requirements for the activity, are received, as are priorities identifying which of the resource requirements are more important than others. Resources are automatically identified based on how well they match the resource requirements, as prioritized, and based on availability. The identified resources are automatically assigned to the activity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is block diagram of one embodiment of a project management system.

FIGS. 2A and 2B show a flow diagram illustrating one embodiment of the overall operation of the system shown in FIG. 1.

FIGS. 3A-3F are illustrative user interface displays.

FIG. 4 shows one embodiment of the project management system in various architectures.

FIGS. 5-10 illustrate various mobile devices.

FIG. 11 is a block diagram of one illustrative computing environment.

### DETAILED DESCRIPTION

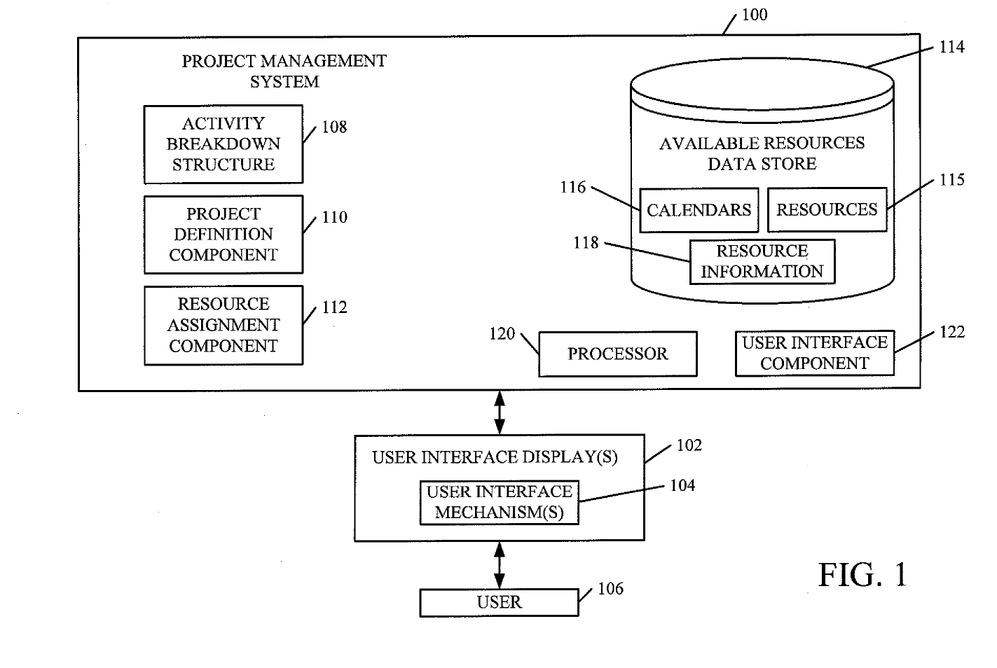

FIG. 1 is a block diagram of one embodiment of a project management system 100. Project management system 100 is shown displaying user interface displays 102, with associated user input mechanisms 104, for interaction by user 106. User 106 illustratively uses the user input mechanisms 104 on displays 102 to control and manipulate project management system 100.

Project management system 100 illustratively includes at least one activity breakdown structure 108, project definition component 110, resource assignment component 112, available resources data store 114 which, itself, includes calendars 116 for a plurality of different resources 115 and resource information 118 for those resources as well. Project management system 100 also illustratively includes processor 120 and user interface component 122.

Project definition component 110 illustratively allows a project manager (such as user 106) to define a project in terms of an activity breakdown structure 108. Resource assignment component 112 is used by user 106 in order to automatically identify and assign resources 115 to the various activities in the activity breakdown structure 108 that defines a given project. This is done by matching resource requirements, input by user 106, against resource information 118 and availability information (or calendars 116) for resources 115.

Processor 120 is illustratively a computer processor with associated memory and timing circuitry (not separately shown). It is illustratively a functional part of project management system 100 and is activated by, and facilitates the functionality of, other components and items of project management system 100.

Data store 114 is shown as a single data store, that is part of project management system 100. It will be noted, however, that data store 114 can be multiple different data stores, and it can be local to system 100, or remote from system 100, and accessible by system 100. In addition, in the embodiment where data store 114 is comprised of multiple different data stores, all can be local, all can be remote, or some can be local while others are remote.

User interface component 122 is illustratively used by other components of project management system 100 to generate user interface displays 102 with user input mechanisms 104. User input mechanisms 104 can be a wide variety of different user input mechanisms, such as text boxes, icons, links, dropdown menus, checkboxes, buttons, etc. In addition, the user input mechanisms 104 can be actuated in a wide variety of different ways. For instance, they can be actuated using a point and click device (such as a mouse or track ball), using a hard or soft keyboard, a keypad, a thumbpad, other buttons or switches, etc. In addition, if project management system 100 includes speech recognition components, the user input mechanisms 104 can be actuated using speech commands. Further, where the device on which user interface displays 102 are displayed is a touch sensitive screen, the user input mechanisms can be actuated using touch gestures (such as with the user's finger, a stylus, etc.).

It will be noted that resources can be allocated to activities in a wide variety of different environments. For instance, the resources can be equipment, machines, meeting rooms, etc. However, for the sake of the present description, the resources are described in human terms. That is, the resources identify individuals with certain skills or capabilities that can perform the tasks in an activity of a project. Thus, project management system 100 can be part of a business system, such as a customer resource management (CRM) system, an enterprise resource planning (ERP) system, a line-of-business (LOB) system, or another type of business system. Therefore, this description is exemplary only, and it could just as easily be applied in the other contexts.

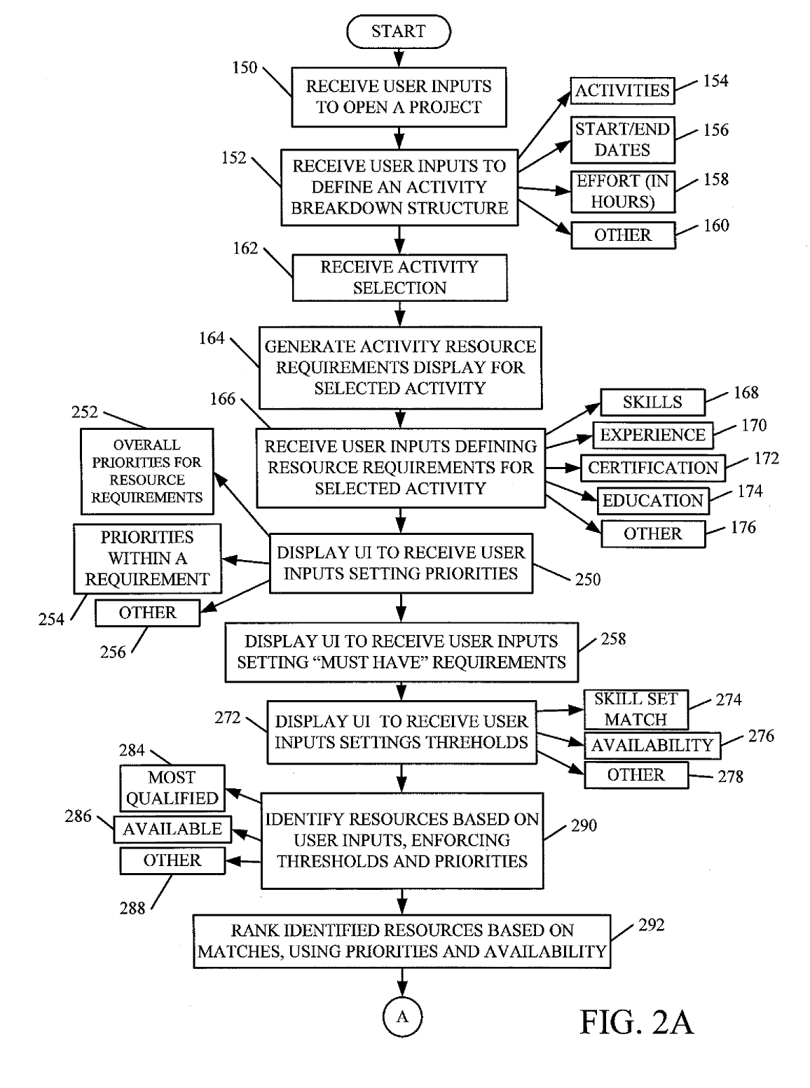

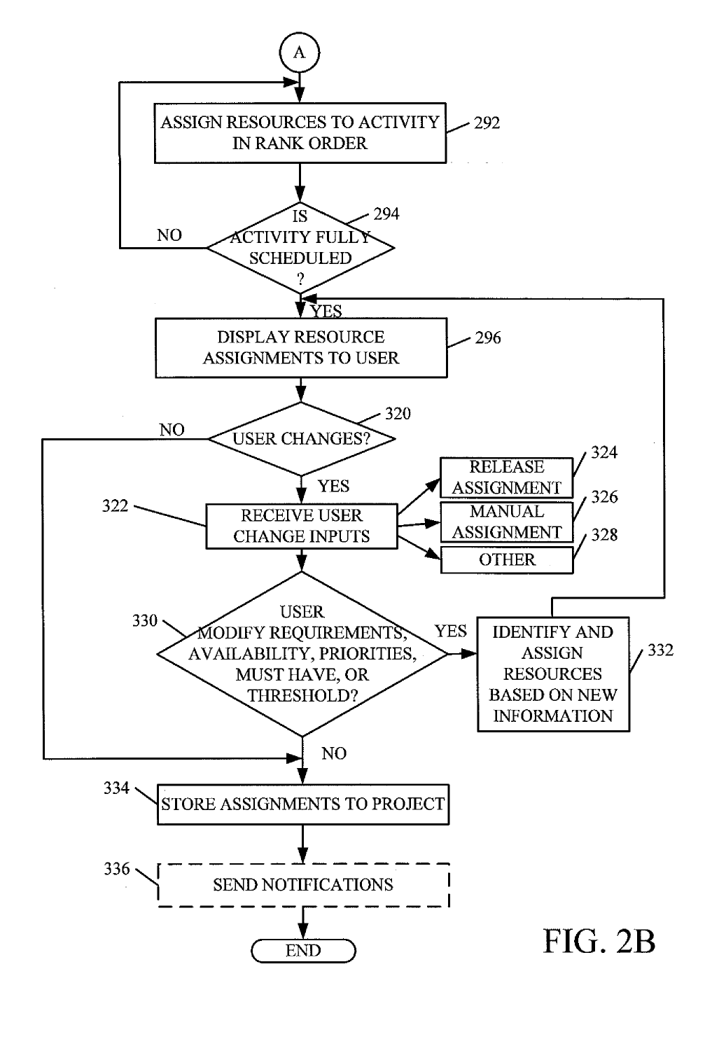

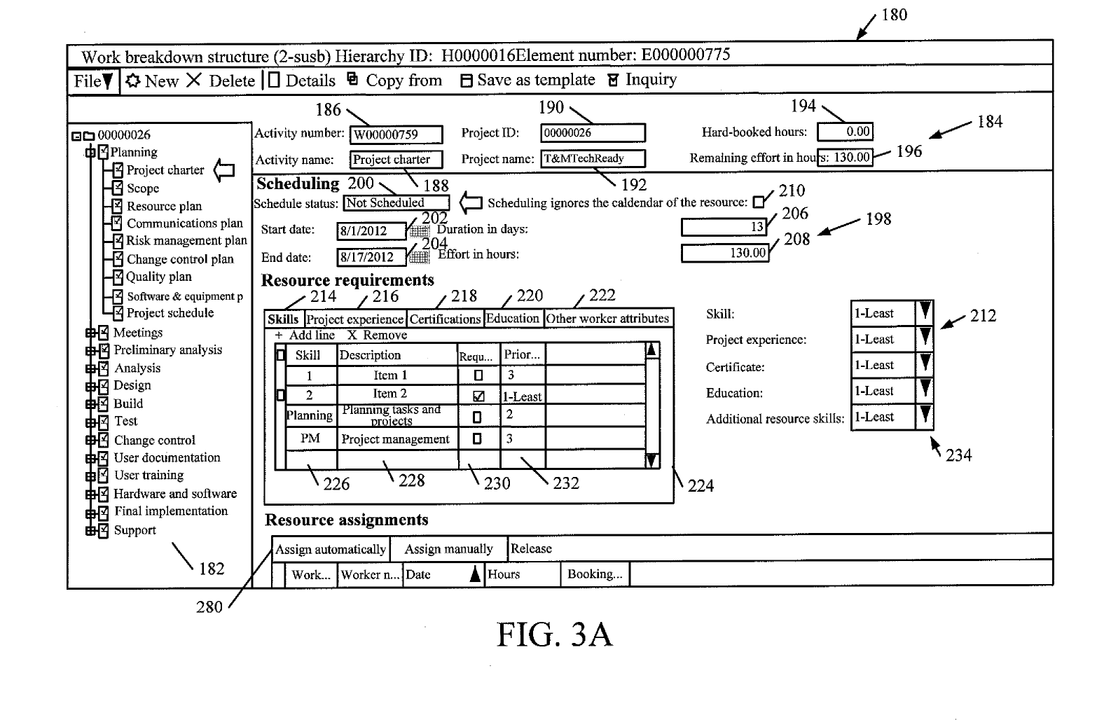

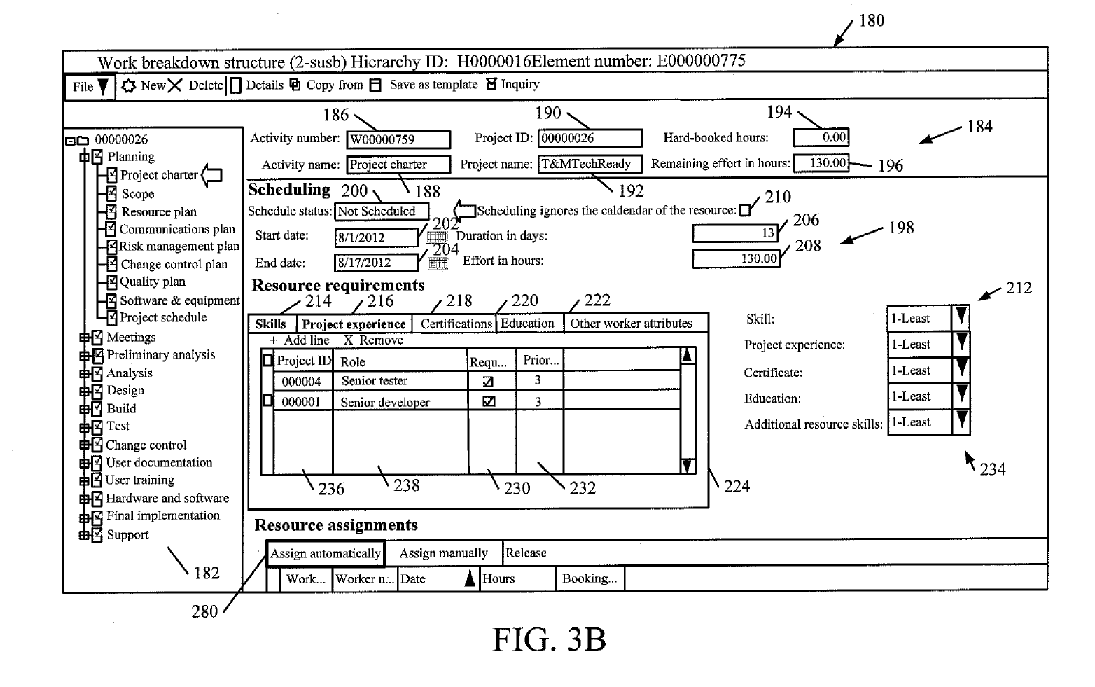

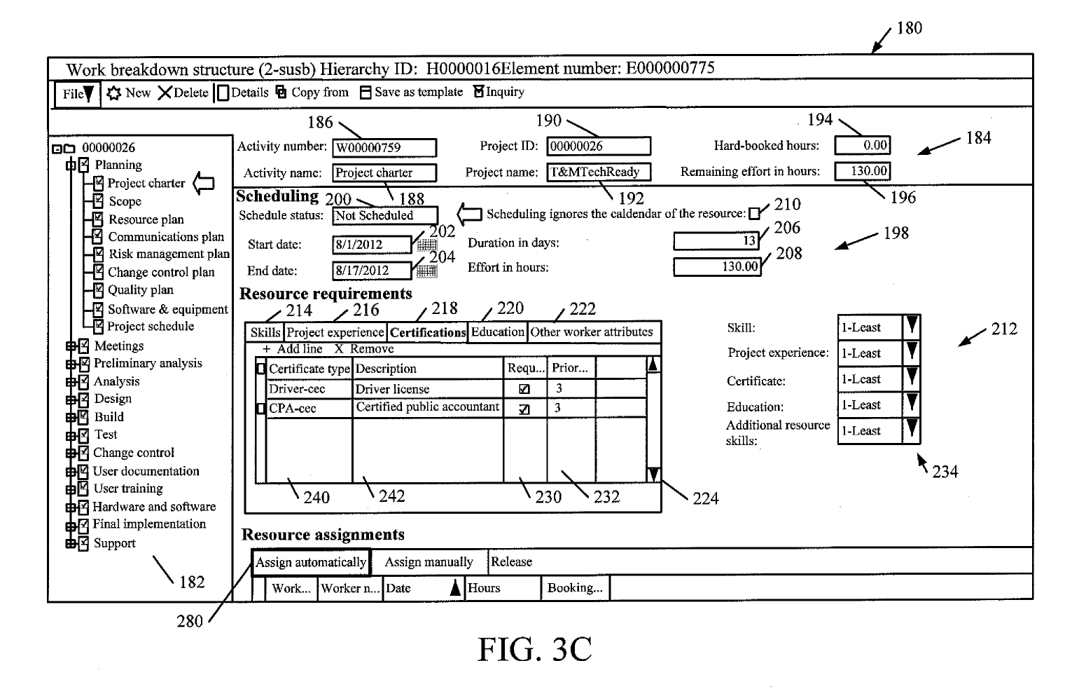

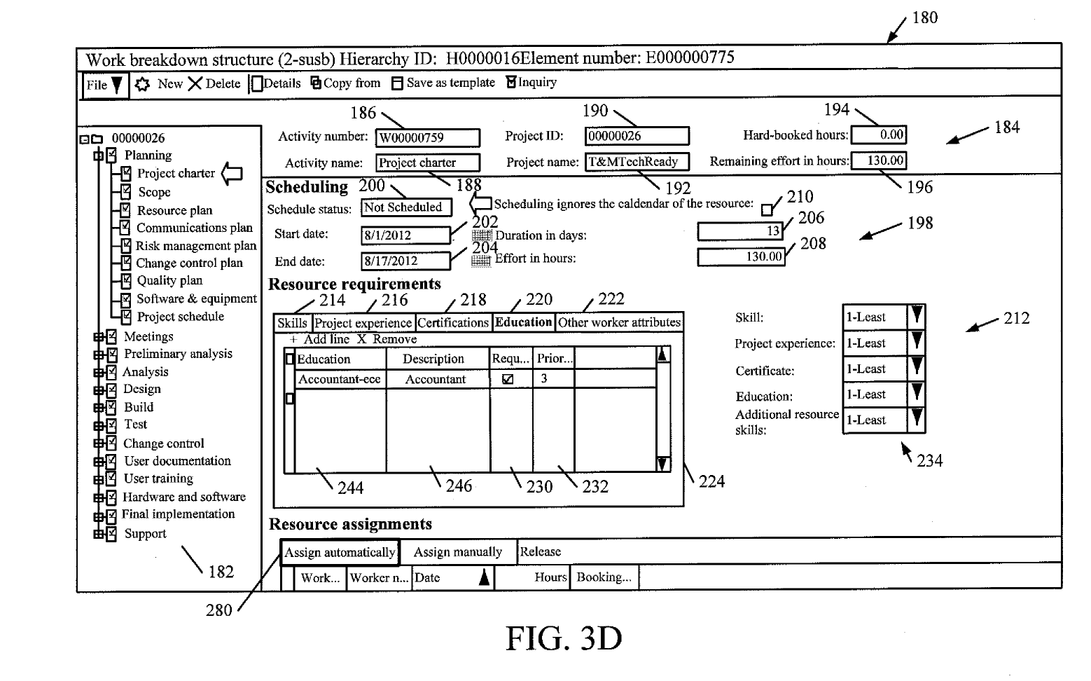

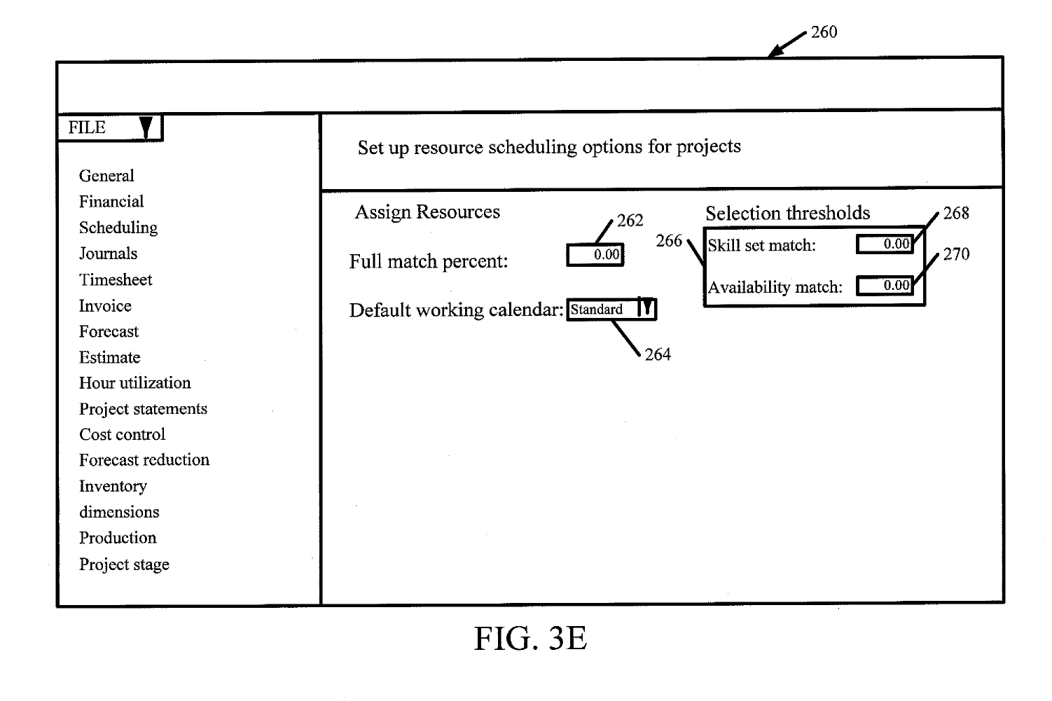

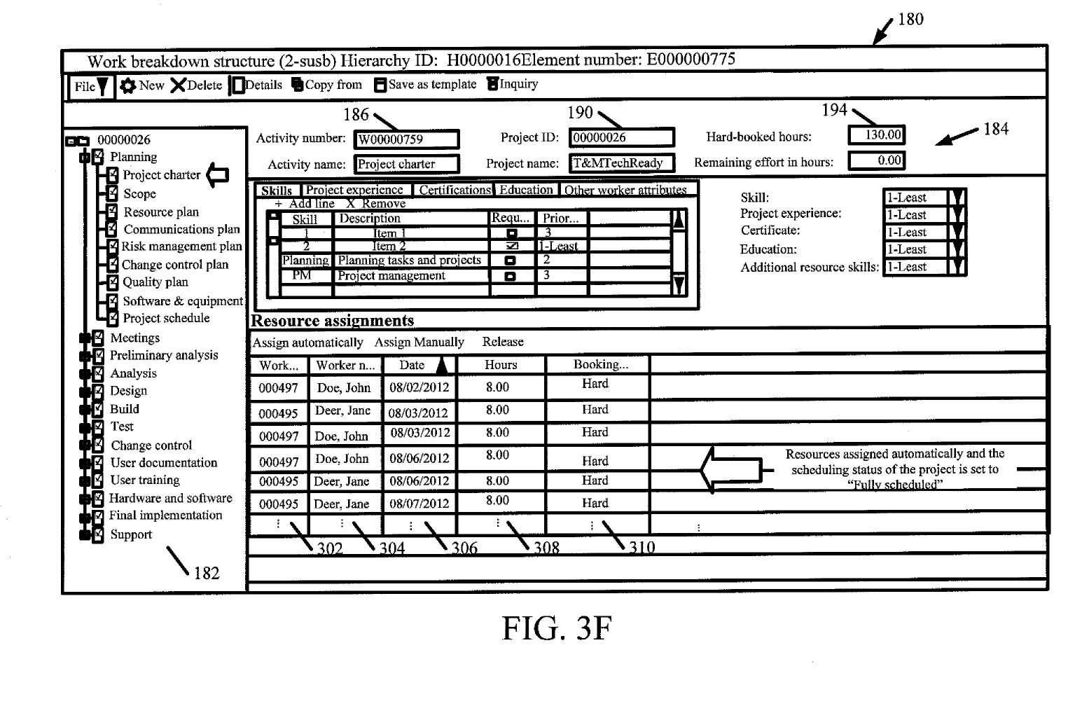

In any case, FIGS. 2A and 2B show a flow diagram illustrating one embodiment of the operation of project management system 100 in assigning resources to an activity that is part of a project. FIGS. 3A-3F are illustrative user interface displays. FIGS. 2A-3F will now be described in conjunction with one another.

User 106 first illustratively uses project definition component 110 to open up a project and begin defining the project. Receiving user inputs to open a project is indicated by block 150 in FIG. 2A. User 106 illustratively provides user inputs to define an activity breakdown structure that defines the overall project or part of the project. This is indicated by block 152 in FIG. 2A. The activity breakdown structure can take a wide variety of different forms but, in one embodiment, it is a hierarchical structure of activities 154 that have start and end dates 156 and an effort level 158 that can be defined in terms of hours of human effort that will likely be used to perform the activity. Of course, the activity breakdown structure can have other information 160 as well.

From the activity breakdown structure, user 106 illustratively selects an activity to assign resources to it. This is indicated by block 162 in FIG. 2A.

Resource assignment component 112 then generates a user interface display 102 that allows user 106 to provide inputs defining the resource requirements for the selected activity. As used herein, resource requirements are attributes of a resource that are desired in order to have that resource assigned to a given activity. For instance, if the activity is to build a software component, a resource requirement may be experience in programming, etc. Generating the user interface display to receive resource requirements for the selected activity is indicated by block 164 in FIG. 2A.

Resource assignment component 112 then receives user inputs defining resource requirements for the selected activity. This is indicated by block 166 in FIG. 2A. In one embodiment, the resource requirements can be defined in terms of skills 168, experience 170, certifications 172, education 174, or other information 176.

FIG. 3A shows one user interface display 180 that illustrates this. User interface display 180 illustratively includes an activity breakdown structure shown generally at 182. Activity breakdown structure 182 is shown as a hierarchical structure of activities. When the user actuates one of the nodes in structure 182, it illustratively expands to show the various activities under that node.

Interface display 180 also illustratively includes an activity description portion 184 that identifies the particular activity for which resources are being scheduled. Portion 184 illustratively includes an activity number 186, an activity name 188, a project identifier 190, a project name 192, number of hard booked hours 194 (that reflects the number of hours of human effort to perform the activity that have already been booked) and a remaining effort hours 196 (that identifies the number of effort hours still unbooked for the activity).

Interface display 180 also illustratively includes a scheduling portion 198. Scheduling portion 198 illustratively shows a scheduled status 200 that indicates whether the activity is not scheduled, partially scheduled, or fully scheduled. Portion 198 also includes a start date 202, an end date 204, both of which are for the given activity, a duration in days 206 that defines the number of days over which the activity is to be performed, and an effort level in hours 208 that defines the number of man hours that may be needed in order to perform the activity. Also, in one embodiment, portion 198 includes a check box 210 that allows user 106 to have resource assignment component 112 ignore the calendars of the individuals that are to be searched to identify resources that can be assigned to the activity. This may be needed, for instance, if the project is behind schedule and the project manager needs extra help on the weekends, after hours, etc. In that case, even though the individuals have calendars that indicate they do not work after 5:00 p.m., the project manager can instruct resource assignment component 112 to ignore the calendars of the individuals and simply search for qualified individuals based on whether they meet the resource requirements needed to perform the activity.

Interface display 180 also illustratively includes a resource requirements portion 212. Resource requirements portion 212 illustratively allows user 106 to identify resource requirements (such as skills 214, project experience 216, certifications 218, education 220, other worker attributes 222) that define the types of desired worker attributes that may be needed by an individual in order to perform the work associated with this activity.

In the embodiment illustrated, the skills tab 214 has been selected. Therefore, a dropdown box 224 lists the skills 226, and a description 228 of the particular skills that are needed for this activity. In addition, dropdown box 224 includes a “required” column 230 that allows the project manager (e.g., user 106) to check those particular skills 226 that are “must have” in order to be assigned to this activity. That is, if a worker does not have a “must have” skill 226, that worker will not be assigned to the activity regardless of other matching attributes. Dropdown box 224 also illustratively includes a priorities column 232 that allows user 106 to prioritize the various skills 226 as to which are most important, in the eyes of user 106. This way, when resource assignment component 112 is matching the resource information 118 for resources 115, against the attributes identified by user 106 in box 224, it can match them according the priorities assigned by user 106 in column 232.

While column 232 allows user 106 to prioritize individual components of a given attribute, user interface display 180 also includes an overall priority selection mechanism 234. Mechanism 234 allows user 106 to prioritize each of the various resource requirements or attributes (214, 216, 218, 220, 222) relative to one another. Therefore, user 106 can not only prioritize individual components within a resource requirement (or attribute) in column 232, but it can prioritize the overall resource requirements (or attributes) related to one another using mechanism 234.

User 106 can illustratively perform these steps for each of the different resource requirements (or attributes) by simply selecting another resource requirement tab and filling out the information in the dropdown box corresponding to that tab. FIGS. 3B-3D show examples of this.

FIG. 3B shows user interface display 180, which is similar to that shown in FIG. 3A, except that the project experience tab 216 has been selected. This allows the user to identify items of project experience that the user 106 would like to see for individuals that are assigned to this activity. In the embodiment shown in FIG. 3B, user 106 can specifically set project identifications in column 236, specific roles in column 238, and again indicated what project experience is required (if any), and its priority, in columns 230 and 232, respectively.

FIG. 3C is similar to FIG. 3B, except that user interface display 180 is shown having the certifications tab 218 selected. This allows user 106 to specify various certification types in column 240, and describe them in column 242. The certification types are those that user 106 illustratively wants to see for individuals who will be assigned to the project.

FIG. 3D is similar to FIG. 3C, except that user interface display 180 has the education tab 220 selected. This allows user 106 to define an education level or degree type in column 244 and a description of that in column 246.

Returning again to FIG. 2A, receiving user inputs defining the resource requirements or resource attributes is indicated by block 166. Displaying the user interface to receive the user input setting priorities is indicated by block 250. Again, the priorities can be overall priorities 252 for the resource requirements (such as those set using mechanism 234 in FIG. 3A) or they can be priorities within a given requirement 254 (such as those set using column 230 in FIG. 3A), or there can be other priorities 256 as well. Receiving the user inputs setting the “must have” requirements (such as in column 230 in FIG. 3A) is indicated by block 258.

User 106 can also illustratively set different scheduling options and thresholds. For instance, FIG. 3E shows a user interface display 260 that illustrates this. FIG. 3E shows that the user can configure resource assignment component 112 to only assign resources that match at least a certain percentage of the requirements set in FIGS. 3A-3D. For instance, in text box 262, the user can enter a percent of full match (e.g., the percent of all resource requirements or attributes set by user 106 that are matched by a given resource 115) which is needed in order even consider a resource as a possible candidate. FIG. 3E also shows that user 106 can set selection thresholds in different ways as shown in box 266. The user can illustratively set a skill set match threshold using mechanism 268 and an availability match threshold using mechanism 270.

The skill set match threshold is illustratively a percent of the skill set requirements that must be matched in order for a given resource to be assigned to the project. If the resource, does not match that percent of the skill set requirements, then the individual is not even considered for assignment to the activity.

The availability match indicates the percent of availability requirements that the resource must match in order to be assigned to the activity. For instance, it may be that the project manager wants only one person to perform all of the work on a given task in an activity. In that case, if a given resource (even if otherwise qualified) is only available for half of the time required to perform the activity, that resource will not be assigned to the activity. Similarly, it may be that the project manager does not wish anyone to be assigned to the resource unless they can at least provide 10 percent of the work. In that case, even the most qualified resource will not be assigned to the activity if they can only provide less than 10 percent of the work. For example, they will not be assigned if they are only available to perform five hours on an activity that requires 100 hours of effort. In one embodiment, the user can also illustratively select the working calendar (or various forms of it) using dropdown menu 264. For instance, the user can select a standard working calendar, a 24 hour working calendar, or any other variation, as desired.

Displaying the user interface display 260 to receive user inputs setting thresholds is indicated by block 272 in FIG. 2A. Setting the skill set match threshold is indicated by block 274, setting the availability match threshold is indicated by block 276, and setting other types of threshold matches is indicated by block 278. Once the user has provided all of the desired information, then (referring again to FIG. 3A) the user simply needs to actuate a suitable user input mechanism, such as the “Assign Automatically” button 280 on user interface display 180. In response, resource assignment component 112 automatically searches available resources 115 in data store 114 comparing the various resource information 118 corresponding to resources 115 against the resource requirements input by the user (including the priorities and thresholds). It also compares the calendars 116 for resources 115 against the availability requirements (or scheduling requirements) input by the user 106 (again including the match threshold).

In one embodiment, resource assignment component 112 performs the matching by first identifying the most highly qualified resources 115, (e.g., by performing a match of the resources against the resource requirements). Then, once the most qualified resources 115 are identified, it matches the resources against the availability or scheduling requirements. Of course, this can be performed in a different order as well. In any case, identifying resources based on the user inputs, enforcing the thresholds and priorities, is indicated by block 282 in FIG. 2A. Sorting by most qualified resources is indicated by block 284, identifying based on availability is indicated by block 286, and identifying resources based on other information is indicated by block 288.

Resource assignment component 112 then ranks the identified resources based on the matches, using priorities and availability. This is indicated by block 290 in FIG. 2A. Resource assignment component 112 then automatically assigns the resources to the activity, in rank order. This is indicated by block 292. In one embodiment, component 112 iteratively assigns the most highly qualified individuals (who have the availably) to the activity until the activity is fully scheduled. This is indicated by block 294.

Once the activity is scheduled, the resource assignments are displayed to user 106. This is indicated by block 296.

FIG. 3F shows a portion of user interface display 180 that illustrates this. It can be seen in resource assignment section 300 in FIG. 3F that matching resources 115 have automatically been assigned to the activity so that it is fully scheduled. Resource assignment section 300 illustratively identifies the resource by worker number 302, by worker name 304, by date on which they will be working on the activity 306, the number of hours 308 they will be putting in on each date, and whether the booking is hard (in that it is confirmed) or soft (in that it is tentative) in booking status 310.

Once the assignments are displayed to user 106, user 106 can illustratively make changes. For instance, if the user picks one of the workers in portion 300 and actuates release button 312, that worker will be released and no longer assigned to the activity. By actuating the manual assignment button 314, user 106 will be navigated to a series of screens where the user can provide inputs to manually assign resources to the activity. Determining that the user is to make changes is indicated by block 320 in FIG. 2B, and receiving the user change inputs is indicated by block 322. The exemplary changes include releasing an assignment 324, making a manual assignment 326, and they could of course include other changes 328 as well.

Resource assignment component 112 then allows the user to go back and modify the resource requirements, an activity, the “must have” requirements, and the various thresholds. For instance, if an activity is not able to be fully scheduled (e.g., to have resources assigned to meet all the needs of the activity), user 106 may loosen the requirements, change the availability dates, revise the priorities, remove some of the “must have” requirements or revise the thresholds, etc. When user 106 provides these inputs (as indicated by block 330 in FIG. 2B) then resource assignment component 112 illustratively identifies and assigns resources based on that new information. This is indicated by block 332. Processing then returns to block 296 where the newly assigned resources are displayed for the user 106.

Once the activity is fully scheduled with resources, and no further changes are made by the user 106, the resource assignments are stored to the given project. This is indicated by block 334. In one embodiment, project management system 100 can optionally send notifications to the resources 115 that have been assigned, letting them know that they have been assigned and also identifying the project specifics. This is indicated by block 336.

It can thus be seen that a user can quickly identify resource requirements (or resource attributes) and have resource assignment component 112 automatically (with one click and no other user inputs) assign qualified and available resources 115 to meet the resource needs of an activity. The user can set priorities and thresholds. This saves time and effort.

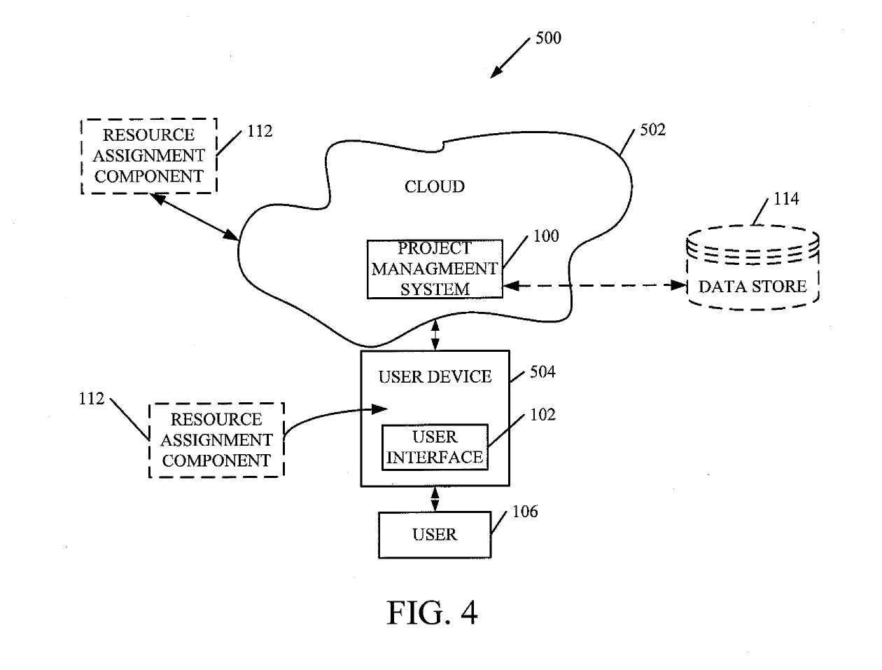

FIG. 4 is a block diagram of system 100, shown in FIG. 1, except that it's elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that project management system 100 is located in cloud 502 (which can be public, private, or a combination where portions are public while others are private). Therefore, user 106 uses a user device 504 to access system 100 through cloud 502.

FIG. 4 also depicts another embodiment of a cloud architecture. FIG. 4 shows that it is also contemplated that some elements of system 100 are disposed in cloud 502 while others are not. By way of example, data store 114 can be disposed outside of cloud 502, and accessed through cloud 502. In another embodiment, resource assignment component 112 is also outside of cloud 502. In addition, in one embodiment, part or all of system 100 can be disposed on user device 504. For instance, FIG. 4 also shows that resource assignment component 112 can be disposed on device 504. Other components can be as well. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

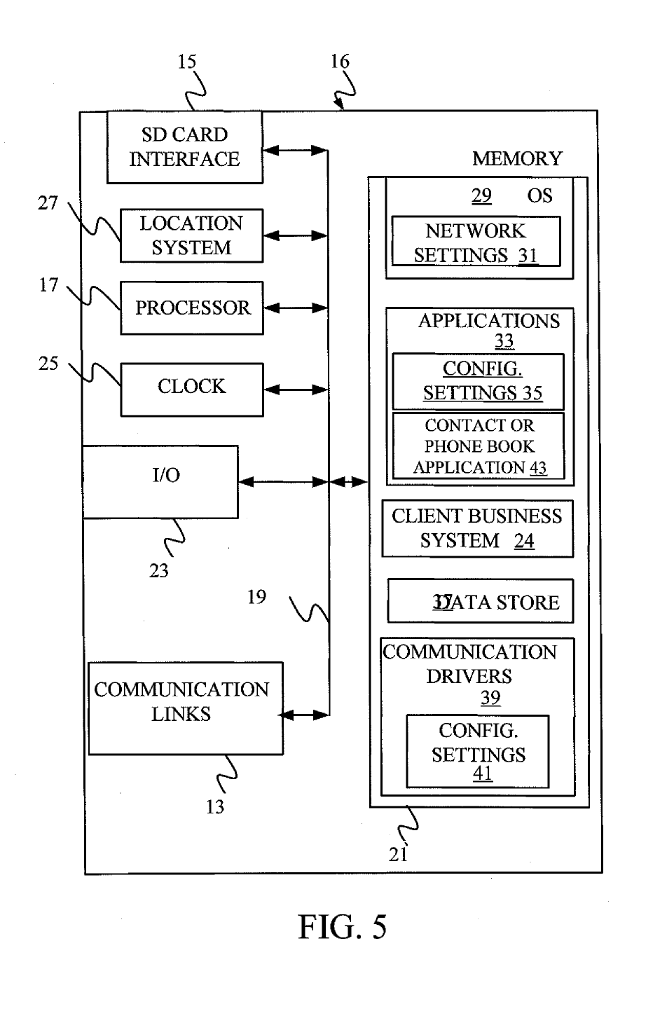

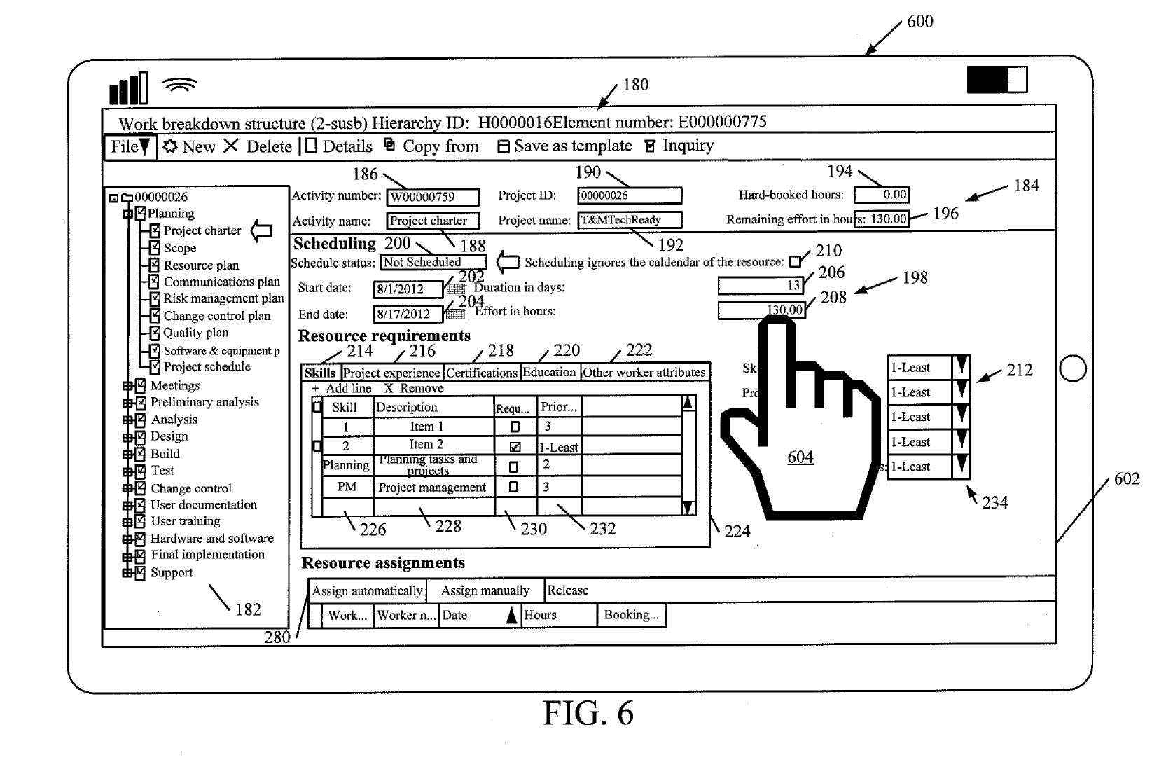

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 120 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Resources 115 or the items in data store 114, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display 180 from FIG. 3A displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

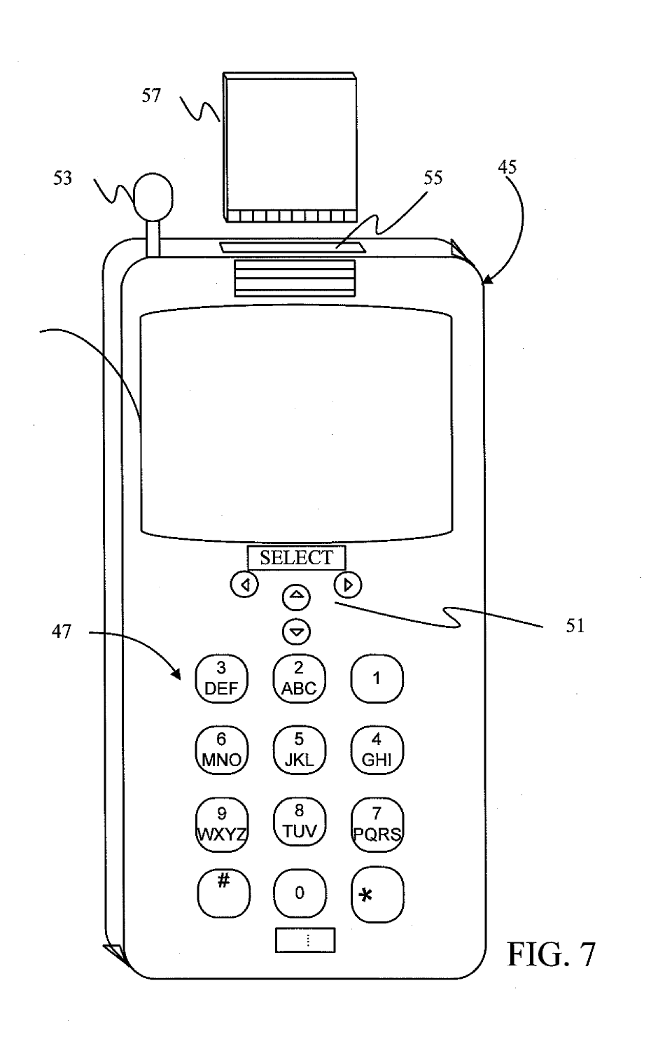

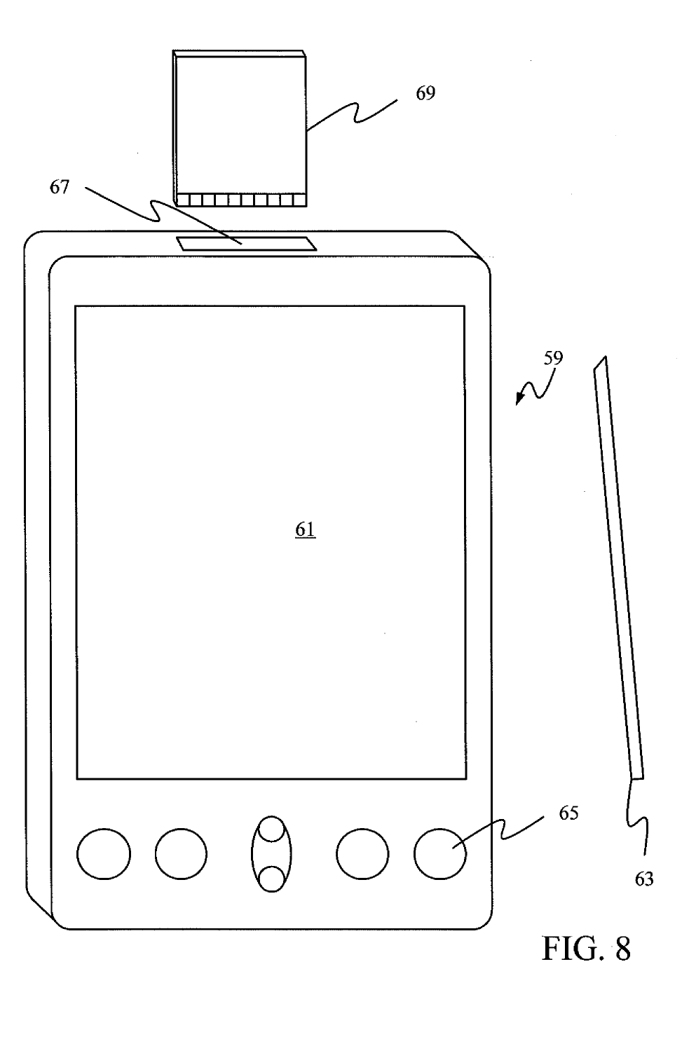

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

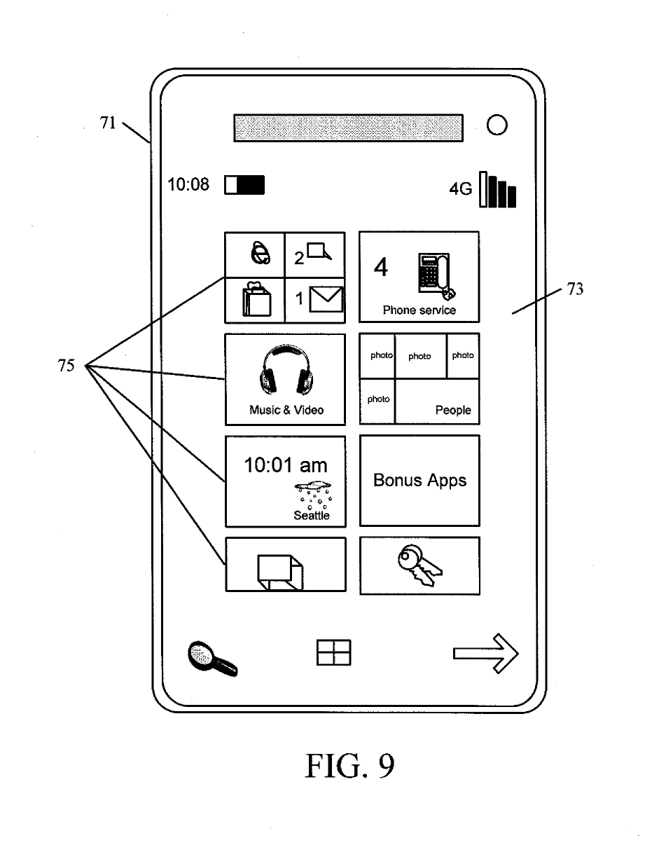

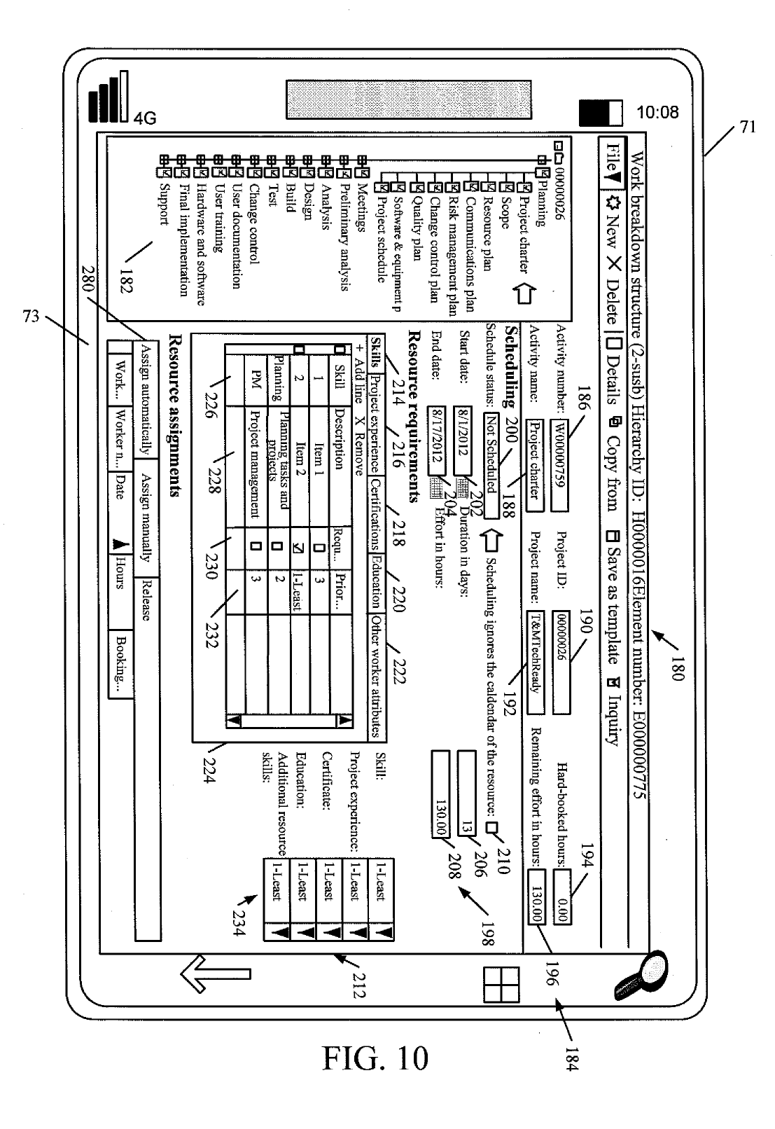

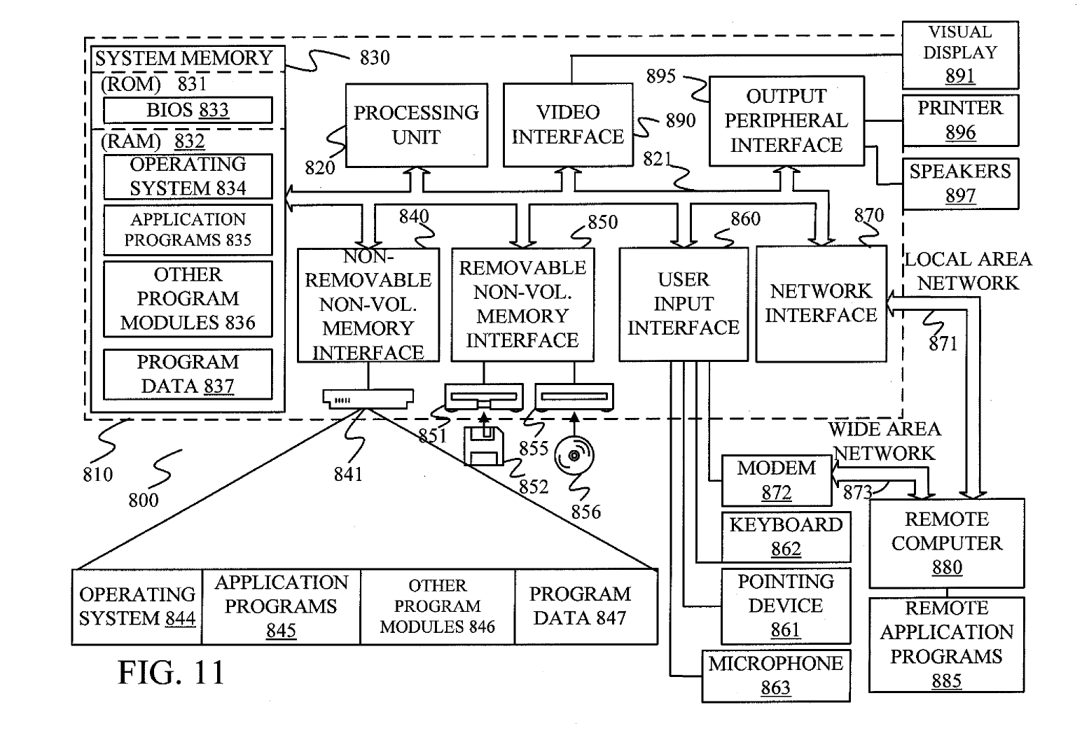

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows smart phone 71 with display 180 shown on it.

Note that other forms of the devices 16 are possible.

FIG. 10 is one embodiment of a computing environment in which system 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 120), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of assigning resources to an activity in a project, comprising:
displaying a resource attribute user interface display to receive resource attribute user inputs indicative of a set of resource attributes of resources to be assigned to an activity;
receiving the resource attribute user inputs;
receiving an assignment user input; and
in response to receiving the assignment user input, automatically identifying resources based on the set of resource attributes indicated by the resource attribute user inputs and assigning the identified resources to the activity.

2. The computer-implemented method of claim 1 wherein displaying the resource attribute user interface display comprises:
displaying an attribute selection mechanism to select a resource attribute;
receiving an attribute selection input selecting a resource attribute to be in the set of resource attributes.

3. The computer-implemented method of claim 1 wherein automatically identifying resources comprises:
matching resource information indicative of attributes of corresponding resources against the set of resource attributes to identify resources that have at least some of the set of resource attributes.

4. The computer-implemented method of claim 3 and further comprising:
displaying a priority setting user interface display to receive priority user inputs indicative of a priority of each of the resource attributes in the set of resource attributes.

5. The computer-implemented method of claim 4 wherein matching comprises:
matching the resource information against the set of resource attributes prioritized as indicated by the priority user inputs.

6. The computer-implemented method of claim 3 and further comprising:
displaying a threshold setting user interface display to receive a match threshold user input indicative of a threshold level of matches against the set of resource attributes.

7. The computer-implemented method of claim 6 wherein automatically identifying comprises:
identifying a resource as a matching resource if the corresponding resource information matches at least the threshold level of the set of resource attributes.

8. The computer-implemented method of claim 3 and further comprising:
displaying an attribute component user input mechanism for the selected resource attribute to receive a component selection input selecting a set of components of the selected resource attribute.

9. The computer-implemented method of claim 8 wherein matching comprises:
matching the resource information against individual components in the selected set of components.

10. The computer-implemented method of claim 9 and further comprising:
displaying a component priority input to receive component priority inputs prioritizing each component in the selected set of components.

11. The computer-implemented method of claim 10 wherein matching comprises:
matching the resource information against individual components in the selected set of components prioritized as indicated by the component priority inputs.

12. The computer-implemented method of claim 3 and further comprising receiving an availability input indicative of a time period when a resource is to be assigned to the activity and identifying comprises:
identifying the resources based first on the set of resource attributes and thereafter based on the availability input.

13. The computer-implemented method of claim 3 wherein assigning comprises:
ranking the resources based on how well the corresponding resource information matches the set of resource attributes; and
assigning the identified resources to the activity in rank order.

14. A project management system, comprising:
a resource assignment component accessing an activity definition defining an activity that is to have qualified resources assigned thereto, and generating a resource attribute definition display that receives attribute definition user inputs indicative of attributes to be possessed by the resources for them to be identified as the qualified resources, accessing resource information indicative of attributes possessed by a plurality of different resources, identifying the qualified resources by matching the attributes indicated by the attribute definition user inputs against the attributes in the resource information, and assigning the qualified resources to the activity; and
a computer processor, being a functional part of the system and activated by the resource assignment component to facilitate generating the resource attribute definition display, identifying the qualified resources and assigning the qualified resources to the activity.

15. The project management system of claim 14 wherein the resource assignment component generates a threshold setting display receiving threshold user inputs defining a threshold level, the resource assignment component identifying the qualified resources as resources that possess the threshold level of attributes indicated by the attribute definition user inputs.

16. The project management system of claim 14 wherein the resource assignment component generates an attribute priority display that receives user priority inputs prioritizing the attributes indicated by the attribute definition user inputs.

17. The project management system of claim 14 wherein the resource assignment component displays an assignment display that shows the qualified resources assigned to the activity.

18. A computer readable storage medium storing computer readable instructions, executable by a computer to perform a method comprising:
displaying a resource attribute user interface display to receive resource attribute user inputs indicative of a set of resource attributes of resources to be assigned to an activity;
receiving an assignment user input; and
in response to receiving the assignment user input, automatically identifying resources based on the set of resource attributes indicated by the resource attribute user inputs and assigning the identified resources to the activity.

19. The computer readable storage medium of claim 18 wherein automatically identifying resources comprises:
matching resource information indicative of attributes of corresponding resources against the set of resource attributes to identify resources that have at least some of the set of resource attributes.

20. The computer readable medium of claim 19 wherein the method further comprises:
displaying a priority setting user interface display to receive priority user inputs indicative of a priority of each of the resource attributes in the set of resource attributes; and
matching the resource information against the set of resource attributes prioritized as indicated by the priority user inputs.
